(19) United States
(12) Patent Application Publication
(10) Pub. No.: US 2026/0268589 A1
(43) Pub. Date: Sep. 10, 2026

(54) TOKEN-DISENTANGLED TRANSFORMER ARCHITECTURES FOR VIEW SYNTHESIS

(71) Applicant: GOOGLE LLC, Mountain View, CA (US)

(72) Inventors: Srinivas Kaza, Cambridge, MA (US); Nithin Gopalakrishnan Nair, Baltimore, MD (US); Jungyeon Park, Albany, CA (US); Stephen Anthony Lombardi, Seattle, WA (US); Xuan Luo, Seattle, WA (US)

(21) Appl. No.: 19/559,606

(22) Filed: Mar. 6, 2026

Related U.S. Application Data
(60) Provisional application No. 63/768,845, filed on Mar. 7, 2025.

(51) Int. Cl. G06T 15/20; G06T 3/18; G06T 7/33; G06T 7/73

(52) U.S. Cl. CPC G06T 15/205; G06T 3/18; G06T 7/344; G06T 7/75

(57) ABSTRACT

A method for view synthesis includes aligning a plurality of representations of a first perspective and a second perspective within a three-dimensional space common to the first perspective and the second perspective and based on a mapping between the first perspective and the second perspective. The method includes transforming the plurality of representations into a first set of descriptors representing the first perspective and a second set of descriptors representing the second perspective and configuring a model based on the first set of descriptors and the second set of descriptors. A third perspective of a second environment is generated based on an input image of the second environment.

Visual data processing allows computing systems to generate digital representations of three-dimensional spaces. Advancements in computer vision provide techniques for novel view synthesis (NVS) to generate virtual perspectives of an environment based on a collection of existing images. Neural architectures facilitate the transformation of visual information into structured formats suitable for rendering and analysis. The synthesis of viewpoints represents a technical area of research within the domain of image-based modeling.

### SUMMARY

A system and method for generating digital representations of three-dimensional spaces provide a technical solution to a problem of visual degradation in generated views. Conventional systems often struggle to combine information from a plurality of perspectives without introducing blurring, ghosting, or unwanted digital artifacts. Digital artifacts occur because the conventional systems cannot distinguish between reliable information from a captured image and speculative information from a generated candidate view. A system architecture described herein implements a model configured as a hardware-integrated gate to allow a computing system to maintain separate feature distributions for descriptors based on a data origin of the descriptors.

A specialized modulation process produces virtual perspectives that are free from noise and irregularities found in traditional synthesis methods. A computing system employs the specialized modulation process to manage a data flow through a model. The specialized modulation process ensures that details of a target perspective are preserved and enhanced by additional context without being corrupted by flaws of candidate perspectives. An architectural configuration of the model enables a generation of sharp, geometrically accurate virtual environments in a three-dimensional space.

In one implementation, a method for view synthesis involves aligning a plurality of representations of a first perspective and a second perspective within a three-dimensional space based on a mapping. The method transforms the plurality of representations into a first set of descriptors representing the first perspective and a second set of descriptors representing the second perspective. The method further involves configuring a model based on the first set of descriptors and the second set of descriptors by applying scale parameters and bias parameters at a plurality of layers. The configuring of the model results in a generated third perspective of a second environment produced by processing an input image through the model.

A transforming of the plurality of representations into the first set of descriptors and the second set of descriptors involves assigning a target perspective to the second set of descriptors and assigning at least one candidate perspective as a source perspective for the first set of descriptors. A generative engine of a generative model produces the candidate perspective. An assignment of specific roles to the different sets of descriptors allows the model to prioritize the target perspective as a ground-truth reference for a generation of a virtual perspective. The generative engine receives orientation data defining an origin and a direction to anchor the candidate perspective to a specific spatial trajectory.

The model includes a plurality of transformer blocks, where each transformer block includes at least one attention layer and at least one multilayer perceptron layer. The transformer blocks have a vector dimensionality that reserves distinct indices for the first set of descriptors and the second set of descriptors through a depth of the model. A maintaining of separate feature distributions prevents a blending of source features into target reconstructions, which facilitates a programmatic exclusion of synthetic edge artifacts during a generate action.

The training of the neural network architecture involves adjusting weights based on a combination of a per-pixel comparison and a comparison between feature layers. The per-pixel comparison measures the numerical difference between a generated perspective and a target perspective. The comparison between feature layers assesses the structural alignment of the generated perspective with the target perspective. The adjusting of the weights minimizes a numerical variance to optimize the fidelity of the reconstructed version of the target perspective.

The described systems and methods can include any combination of the described aspects and features, and the described systems and methods are not limited to the specific combinations set forth herein. Further details of implementations are set forth in the accompanying drawings and the description below.

### BRIEF DESCRIPTION OF THE DRAWINGS

The accompanying drawings, which are incorporated in and constitute a part of the specification, illustrate aspects of the subject matter and, together with the description, serve to explain the principles of the subject matter.

FIG. 1 is a conceptual diagram illustrating example visual results produced by a neural network architecture.

FIG. 2 is a block diagram illustrating an example system architecture including a data pipeline and a neural network architecture.

FIG. 3 is a block diagram illustrating an example data pipeline configured to generate data representations representing a plurality of perspectives.

FIG. 4 is a conceptual diagram illustrating an example assignment of data tokens derived from a plurality of perspectives.

FIG. 5 is a block diagram illustrating an example arrangement of transformer blocks within a neural network architecture.

FIG. 6 is a block diagram illustrating an example transformer block configured to perform modulation of data tokens.

FIG. 7 is a flow chart illustrating an example method for generating data tokens and training a neural network architecture.

FIG. 8 is a flow chart illustrating an example method for generating a perspective of an environment.

FIG. 9 is a block diagram illustrating an example computing system that may be employed to implement the technical solutions described herein.

Like reference numbers may refer to like elements.

### DETAILED DESCRIPTION

The systems and methods described herein provide a technical solution to the hardware inefficiencies and feature alignment limitations of existing view synthesis technologies. Existing architectures for generating novel perspectives often suffer from a feature alignment problem where a processing system performs uniform arithmetic operations on both source data and target data. Such uniform processing causes an infusion of visual artifacts, such as ghosting, stippling, or synthetic edge artifacts, from synthetic or noise-laden source views into a final reconstruction. The common processing of disparate data types prevents a computing system from distinguishing between candidate features and ground-truth features, resulting in a persistent computational burden and high variance in reconstruction fidelity. To address the feature alignment problem and the resulting data degradation, the system architecture described herein implements a token-disentangled modulation process. In some implementations, the token-disentangled modulation process reconfigures a processing system into a hardware-integrated gate that manages data paths for different token types based on categorical metadata. By employing layer-wise scale parameters and bias parameters that differentiate source tokens from target tokens, the computing system maintains distinct feature distributions throughout a depth of a neural network architecture (which may also be referred to herein as a model). The maintaining of distinct feature distributions facilitates the employment of large-scale synthetic training data while excluding synthetic edge artifacts during a fusion of features. The architectural configuration reduces an allocation of modeling capacity to redundant source features, reducing a number of processor cycles and increasing memory throughput during novel view synthesis.

Existing technologies, such as a decoder-only transformer architecture (which may also be referred to herein as a conventional model) or a geometry-free feed-forward network, fail to provide a technical solution for the disentanglement of source features and target features. Conventional models typically concatenate source representations and target representations into a shared stochastic space where the source representations and the target representations converge toward similar representations at all layers of a transformer block. The convergence results in a transformer network allocating a portion of a modeling capacity to modify source descriptor information that is ultimately discarded, creating a computational bottleneck that reduces efficiency and increases memory requirements. Furthermore, existing technologies lack a mechanism to isolate visual noise or compression artifacts present in source views, causing the artifacts to propagate into a generated target view. The limitations of existing technologies result in a fragmented reconstruction process where a computing system functions as a passive interpolator rather than a context-aware synthesizer capable of filtering out-of-distribution noise.

The systems and methods described herein provide a technical solution via an unconventional token-disentangled (Tok-D) transformer architecture that transforms a view synthesis pipeline. In some implementations, a technical implementation for the transformation includes a modulation unit integrated into a stack of transformer blocks. The Tok-D transformer architecture provides a specific improvement to the functioning of a computing system by regulating a distribution of feature representations. For example, the Tok-D transformer architecture employs an indicator variable to detect a token origin (e.g., whether a descriptor originates from a source region of an environment or a target region of the environment) and authorize a modulation unit to perform a layer-wise affine transformation. Differentiated activation based on the token origin prevents an unnecessary blending of high-frequency artifacts from source tokens into target tokens, thereby preserving the geometric integrity of a reconstructed scene. The injection of modulation parameters directly into a processing path of a transformer block enables the model to cleanly delineate between source representations and target representations, which facilitates a seamless integration of features from synthetically-generated imagery without a degradation of ground-truth features. The clean delineation of representations enables a computing system to maintain a persistent semantic state across disparate visual perspectives and effectively manage the integration of synthetic training data.

Building on the token-disentangled transformer architecture, a general overview of the system involves an unconventional sequence of operations for processing multi-view data and spatial coordinates. A data pipeline generates a plurality of candidate perspectives and performs an analysis to identify a target perspective and a source perspective. An identification of the target perspective and the source perspective triggers a generation of an indicator variable. The indicator variable encapsulates a token origin as a categorical metadata signal for transmission between logical modules. In some implementations, the indicator variable serves as a trigger for a retrieval of scale parameters and bias parameters from a modulation unit. A transformer block employs the source tokens, the target tokens (which may also be referred to herein as descriptors), and the modulation parameters to generate a refined feature representation. The transformer block facilitates visual consistency by extracting stylistic attributes and determining a target viewpoint within a shared coordinate system (which may also be referred to herein as a three-dimensional space). The specific sequence of operations, where a categorical metadata signal correlates with a transformer depth to trigger a targeted affine transformation via the modulation parameters, overcomes the routine limitations of generic transformers by enabling the computer to perform a function of selective noise rejection at the layer level, resulting in a reduction of computational variance and a programmatic exclusion of synthetic edge artifacts.

As used herein, an environment may refer to a digital representation of a three-dimensional space, such as a scene captured via a plurality of images or a synthetic space generated via a generative model. An environment may also refer to a first environment (e.g., a training environment) or a second environment (e.g., an inference environment). A three-dimensional space may also refer to a shared coordinate system or a unified spatial framework established via a warping operation or a geometric alignment of a plurality of perspectives.

As used herein, a perspective may refer to a visual representation of an environment from a specific viewpoint. A source perspective may refer to a visual representation of an environment that provides a visual context for a scene. A source perspective may also be referred to herein as a first perspective. A target perspective may refer to a visual representation of an environment that provides a ground-truth representation for a reconstruction. A target perspective may also be referred to herein as a second perspective. A generated virtual perspective may refer to a visual representation generated by a model based on a target viewpoint. A generated virtual perspective may also be referred to herein as a third perspective.

As used herein, a descriptor may refer to a multidimensional vector representation of visual information, geometric information, or a combination thereof. A descriptor may also be referred to herein as a data token. Source tokens may refer to a first set of descriptors representing a source perspective, such as a candidate perspective generated via a multi-view diffusion process. Source tokens may also be referred to herein as a first set of data tokens. Target tokens may refer to a second set of descriptors representing a target perspective, such as a conditioning image or a ground-truth image. Target tokens may also be referred to herein as a second set of data tokens. Reconstructed tokens may refer to a set of descriptors produced by a model that represent a generated version of the target tokens. Reconstructed tokens may also be referred to herein as a third set of data tokens or reconstructed descriptors.

As used herein, coordinate data defining an origin and a direction may refer to a geometric construct, such as a Plücker coordinate, that defines a direction and an origin for a pixel in a three-dimensional space. Coordinate data defining an origin and a direction may also be referred to herein as an orientation, a ray, or ray-based coordinate data. A geometric relationship may refer to a mathematical mapping between viewpoints, such as a relative rotation and translation matrix or a set of parameter differences between a first camera pose and a second camera pose. A representation may refer to a structured data object, such as a patch-based image embedding, a ray-based coordinate representation, or a combination thereof. A representation may also be referred to herein as an input representation or raw evidence.

As used herein, an indicator variable may refer to a categorical metadata signal, such as a numerical value or a bit flag, that identifies a token origin associated with a source perspective or a target perspective. The indicator variable identifies whether a data token belongs to a first set of data tokens (source tokens) or a second set of data tokens (target tokens). Modulation parameters may refer to a set of numerical values, such as scale parameters and bias parameters, used to perform an affine transformation of data tokens.

As used herein, a transformer block may refer to a computational unit including at least one attention layer and at least one multilayer perceptron layer. A model may refer to a neural network architecture, a trained view synthesis model, or a structural genus of processing layers. A model may also be referred to herein as a Ray-Transformer or a Tok-D transformer architecture. Layer-wise modulation may refer to the applying of scale parameters and bias parameters at a plurality of layers within a transformer block. Layer-wise modulation may also refer to an application of scale parameters and bias parameters at an input of a multi-head self-attention layer and at an input of a multilayer perceptron layer within each transformer block of a stack of transformer blocks.

As used herein, synthetic edge artifacts may refer to visual irregularities produced as a byproduct of a generative process, such as stippling, ghosting, or inconsistent boundary definitions. A generate action may refer to a process of synthesizing or producing a visual output based on reconstructed descriptors. A generated representation may refer to a visual output generated by a reconstruction engine based on reconstructed tokens. A stochastic representation may refer to a multidimensional set of numerical noise values, such as a stochastic noise representation or a numerical noise distribution, that serves as a foundational data state for a diffusion process. An unpatchifying operation may refer to a computational process for converting a sequence of descriptors into a visual representation, such as a process employing a linear layer with an optional activation or normalization in conjunction with a reshape operation to convert each token in a sequence of tokens into a patch with a fixed size.

As used herein, a vector dimensionality may refer to a numerical capacity of a processing path within a neural network architecture, such as a hidden layer size, that allows for the allocation of specific indices to represent source or target features. A moving averaging may refer to a parameter update technique where a current state of a model is calculated as a weighted combination of a previous state and a new gradient-based update to reduce numerical variance.

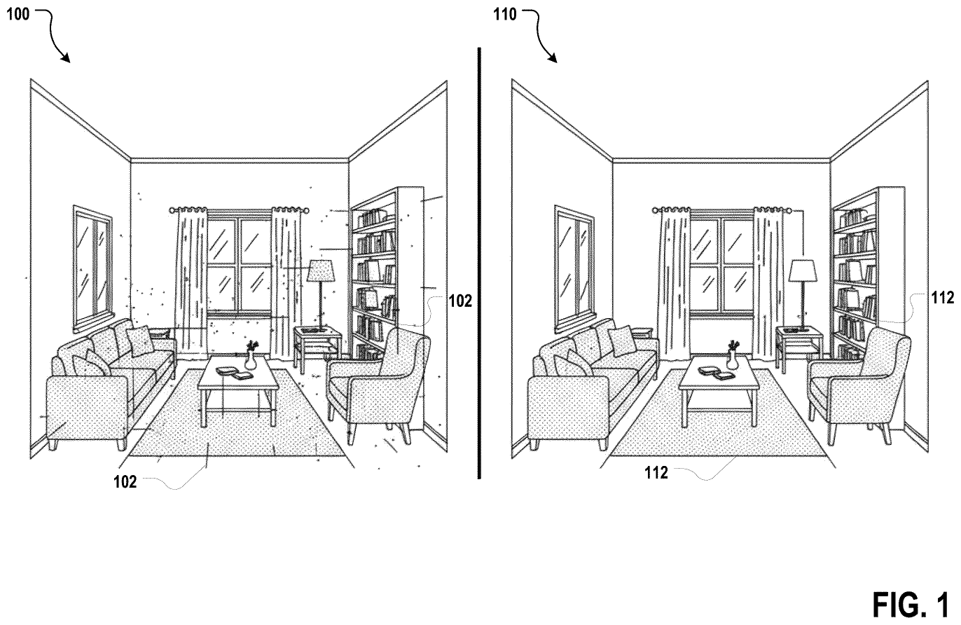

FIG. 1 illustrates a comparison between an artifact-prone representation 100 and a high-fidelity representation 110. The artifact-prone representation 100 represents a visual result produced by a conventional neural network architecture and includes visual artifacts 102 such as broken outlines, ghosting, or stippling. The visual artifacts 102 in the artifact-prone representation 100 result from a common processing of source tokens and target tokens during a reconstruction process. The high-fidelity representation 110 represents a visual result produced by a neural network architecture and includes reconstructed features 112, such as sharp edge definitions and consistent geometric alignment. The sharp edge definitions and the consistent geometric alignment in the reconstructed features 112 are produced in response to the applying of scale parameters and bias parameters that differentiate the source tokens and the target tokens within the neural network architecture. The neural network architecture generates the high-fidelity representation 110 by processing the source tokens representing a plurality of source viewpoints and the target tokens representing a target viewpoint, resulting in a generated view incorporating spatial context from the source viewpoints into a reconstructed version of the target viewpoint. The applying of the scale parameters and the bias parameters within the neural network architecture produces the high-fidelity representation 110 and programmatically excludes visual artifacts 102 present in data representations of the plurality of source viewpoints from a reconstruction of the high-fidelity representation 110.

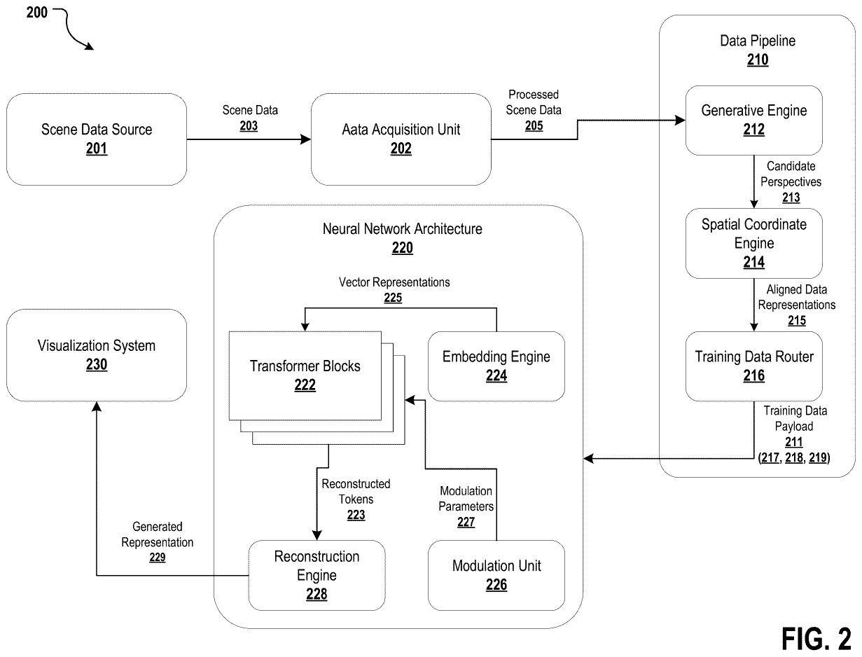

FIG. 2 illustrates an example system architecture 200 for generating representations of three-dimensional environments. System architecture 200 includes a coordinated arrangement of computational modules configured to transform visual information into generated perspectives. System architecture 200 includes a scene data source 201, a data acquisition module 202, a data pipeline 210, and a neural network architecture 220. System architecture 200 facilitates the scaling of view synthesis by employing synthetic data while excluding artifacts from a final reconstruction.

Scene data source 201 represents a data source, such as a service, a data repository, or a physical capture system that stores visual information and spatial metadata. Scene data source 201 provides scene data 203 associated with a training environment. Scene data 203 includes captured images and corresponding camera parameters. Data acquisition module 202 includes an interface for receiving the scene data 203. Data acquisition module 202 retrieves conditioning images and associated camera parameters from the scene data 203 to initialize a synthesis process. To establish a foundation for synthetic data generation, the data acquisition module 202 provides processed scene data 205 to a generative engine 212 of a data pipeline 210. Processed scene data 205 includes the visual information and the associated camera parameters formatted for generation of candidate perspectives.

Data pipeline 210 constitutes a computational framework for generating and transforming training data. Data pipeline 210 performs a sequence of computational processes to create spatially consistent multi-view data. Data pipeline 210 includes a generative engine 212. Generative engine 212 employs a multi-view diffusion model to produce a plurality of candidate perspectives 213 of a first environment. Generative engine 212 samples camera trajectories to define viewpoints for the plurality of candidate perspectives 213. Generative engine 212 transforms initial numerical distributions (which may also be referred to herein as a probability distribution) into visual features through a series of diffusion steps. Generative engine 212 receives target camera poses as raymaps (which may also be referred to herein as coordinate data defining an origin and a direction, or an orientation) and provides the raymaps to a cross-attention layer of the multi-view diffusion model. Generative engine 212 performs a denoising process where the cross-attention layer correlates stochastic noise representations with the raymaps. The correlation of the stochastic noise representations with the raymaps results in the generation of candidate perspectives 213 characterized by a geometric alignment with the sampled camera trajectories. In some implementations, the generative engine 212 is initialized with random numerical weights as a foundational state for a training process. In other implementations, the generative engine 212 is pre-trained in response to a receipt of a rules-based system using a synthetic dataset of geometric primitives to establish a baseline spatial awareness.

Spatial coordinate engine 214 includes computational logic for enforcing geometric consistency across each perspective. Spatial coordinate engine 214 performs warping operations on stochastic data representations for each perspective using a geometric relationship defining relative camera poses. The alignment of data representations by spatial coordinate engine 214 results in a three-dimensional space common to each perspective of the plurality of candidate perspectives based on a mapping established by the geometric relationship, which facilitates a reduction in a generation of spatial artifacts.

Training data router 216 includes data routing logic for assigning roles to visual representations during a training phase. Training data router 216 receives aligned data representations 215 from a spatial coordinate engine 214. Training data router 216 assigns a conditioning image of the training environment as a target perspective and assigns generated candidate perspectives as source perspectives. The assignment of roles by training data router 216 results in a training data payload 211 that facilitates an optimization of the neural network architecture 220. The training data payload 211 includes source tokens 217, target tokens 218, and an indicator variable 219. The source tokens 217 and the target tokens 218 correspond to the source and target roles described above with reference to FIG. 1. Training data router 216 provides the training data payload 211 to a neural network architecture 220 in response to a role assignment, causing the neural network architecture 220 to perform an optimization of parameters toward a reconstruction of ground-truth features.

Neural network architecture 220 constitutes a structural arrangement of neural layers configured to process the training data payload 211. Neural network architecture 220 receives the training data payload 211 from the training data router 216 of the data pipeline 210. The neural network architecture 220 includes a plurality of layers configured to apply scale parameters and bias parameters at each layer to differentiate the source tokens 217 from the target tokens 218 based on the indicator variable 219. The applying of the scale parameters and the bias parameters within the plurality of layers produces a structural differentiation that prevents a blending of visual artifacts during an optimization of weights. Following the optimization of weights, the neural network architecture 220 constitutes a trained view synthesis model. Neural network architecture 220 includes an embedding engine 224, a modulation unit 226, and a stack of transformer blocks 222.

Embedding engine 224 includes a set of transformation layers configured to partition images into discrete portions and integrate the discrete portions with ray-based coordinate data. Embedding engine 224 transforms the discrete portions and the ray-based coordinate data into multidimensional vectors formatted for processing within the stack of transformer blocks 222. The embedding engine 224 provides the multidimensional vectors to the stack of transformer blocks 222 as vector representations 225.

Modulation unit 226 includes circuitry or software logic configured to perform layer-wise modulation of the source tokens 217 and the target tokens 218. The modulation unit 226 applies scale parameters and bias parameters at each layer of a plurality of layers to produce distinct feature representations for the source tokens 217 and the target tokens 218 based on the indicator variable 219. The modulation unit 226 performs a multi-step transformation to generate the modulation parameters 227. First, the modulation unit 226 maps the categorical value of the indicator variable 219 to a style embedding 507 using a look-up table or a learnable embedding layer. Second, the modulation unit 226 processes the style embedding 507 through a series of linear layers to project the style embedding 507 into a parameter space that matches a vector dimensionality of the stack of transformer blocks 222. The linear layers generate a pair of vectors for each layer of the stack of transformer blocks 222, where a first vector represents scale parameters and a second vector represents bias parameters. The modulation unit 226 provides the scale parameters and the bias parameters to the stack of transformer blocks 222 as modulation parameters 227. Within the stack of transformer blocks 222, each transformer block employs the modulation parameters 227, resulting in a maintenance of separate feature distributions for the source tokens 217 and the target tokens 218. The applying of the modulation parameters 227 produces a structural differentiation that prevents a blending of visual artifacts during a synthesis of a virtual perspective.

Stack of transformer blocks 222 includes a plurality of sequential processing blocks, where a transformer block includes at least one attention layer and at least one multilayer perceptron layer. Stack of transformer blocks 222 receives the distinct feature representations and performs spatial reasoning to generate a virtual perspective (which may be referred to herein as a third perspective) of an inference environment (which may be referred to herein as a second environment). The stack of transformer blocks 222 provides processed features to a reconstruction engine 228 as reconstructed tokens 223. The reconstructed tokens 223 represent a generated version of the target tokens 218 as optimized for the second environment.

Reconstruction engine 228 includes conversion logic for transforming reconstructed tokens 223 into a visual format. The reconstruction engine 228 receives the reconstructed tokens 223 from the stack of transformer blocks 222 and performs an unpatchifying operation to generate a generated representation 229. The unpatchifying operation involves employing a linear layer with an optional activation or normalization in conjunction with a reshape operation to convert each token of the reconstructed tokens 223 into a patch with a fixed size. The reconstruction engine 228 provides the generated representation 229 to a visualization system 230. Visualization system 230 represents a technical endpoint for the view synthesis process, such as a display device, a storage medium, or a computer vision application.

The system architecture 200 employs a baseline workflow for view synthesis to establish fundamental data representations. The neural network architecture 220 enhances the baseline workflow to produce the comparative results illustrated in FIG. 1. A baseline workflow for view synthesis involves the processing of source representations

$$( e . g . , source image patches {I}_{ij}^{s} ∈ {ℝ}^{p \times p \times 3} )$$

and Plücker coordinate representations

$$( e . g . , coordinate patches {P}_{ij}^{s} ∈ {ℝ}^{p \times p \times 6} ) ,$$

where i denotes an image index and j denotes a token index. Target viewpoints are defined by target Plücker coordinate representations

$${P}_{j}^{t} ∈ {ℝ}^{p \times p \times 6} .$$

In some implementations, an embedding engine 224 of the neural network architecture 220 transforms the source representations

$$( e . g . , source image patches {I}_{ij}^{s} P )$$

and the Plücker coordinate representations

$$( e .. g . , Pl \ddot{u} cker coordinate patches {P}_{ij}^{s} )$$

together using a near layer represented by Equation (1):

$${S}_{ij} = Linear ( [ {I}_{ij}^{s} , {P}_{ij}^{s} ] ) \qquad ( 1 )$$

The embedding engine 224 generates source tokens 217 (represented as Sᵢⱼ∈ [symbol] ^{d}) to encapsulate both visual features and geometric ray data. In some implementations, a first transformation layer within the neural network architecture 220 transforms the target Plücker coordinates

$${P}_{j}^{c} ∈ {ℝ}^{p \times p \times 6}$$

using a linear layer defined by Equation (2) to produce target tokens 218, which may also be referred to herein as a set of descriptors, (represented as Tⱼ∈ [symbol] ^{d}):

$${T}_{ij} = Linear ( {P}_{ij}^{t} ) \qquad ( 2 )$$

A neural network architecture 220, such as a transformer network M, performs a training process to reconstruct target image tokens. In some implementations, the transformer network M transforms the target tokens 218 (represented as Tⱼ) based on the source tokens 217 (represented as Sᵢⱼ) following the relationship defined in Equation (3) to produce reconstructed tokens 223

$$( represented as {O}_{j}^{t} ∈ {ℝ}^{d} ) .$$

The transformer network M employs the source tokens 217 as a spatial context for generating the reconstructed tokens 223

$$( represented as {O}_{j}^{t} ) ,$$

resulting in generated features characterized by a geometric consistency with the source perspectives.

$${O}_{j}^{t} = M ( {T}_{j} \vert Sij ) \qquad ( 3 )$$

In some cases, the transformer network M employs the source tokens 217 as a spatial context for generating the reconstructed tokens 223, ensuring that the generated features are geometrically consistent with the source perspectives.

In some implementations, a detokenizer within the reconstruction engine 228 employs a second transformation layer to convert the reconstructed tokens 223

$$( represented as {O}_{j}^{t} )$$

into target image embeddings Tⱼ∈ [symbol] ^{p×p×3} according to Equation (4):

$${T}_{j} = Linear ( \vert {O}_{j}^{t} \vert ) \qquad ( 4 )$$

In some cases, the target image embeddings are processed via an unpatchifying operation to generate the generated representation 229.

A training process for the neural network architecture 220 is supervised through an optimization of a composite objective function L that includes a weighted combination of a mean square error loss MSE(I, Î) and a perceptual similarity loss (such as a learned perceptual image patch similarity (LPIPS) loss: LPIPS(I, Î)). The applying of the weighted combination of the mean square error loss and the perceptual similarity loss results in a reduction of numerical variance and a closer alignment with human visual perception during image reconstruction. In some implementations, the composite objective function L is defined by Equation (12):

$$L = MSE ( I , \hat{I} ) + λ * LPIPS ( I , \hat{I} ) . \qquad ( 12 )$$

The neural network architecture 220 calculates a value for the composite objective function L based on a comparison between a reconstructed target view I and a ground-truth target view Î of a training environment. The reconstructed target view I is derived from the reconstructed tokens 223 and the ground-truth target view Î is associated with the target tokens 218. The neural network architecture 220 evaluates performance using concrete metrics, such as a peak signal-to-noise ratio (PSNR) to measure reconstruction fidelity and a structural similarity index measure (SSIM) to assess perceived visual quality. In some implementations, the neural network architecture 220 also employs a learned perceptual image patch similarity (LPIPS) metric to align the reconstructed tokens 223 with human visual perception. Within the composite objective function L, a scaling factor λ represents a numerical weight, such as a value of 0.5, that adjusts a contribution of the perceptual similarity loss LPIPS(I, Î) relative to the mean square error loss MSE(I, Î). The training process facilitates the reduction of artifacts and the consistent geometric alignment illustrated in the high-fidelity representation 110 of FIG. 1.

In some cases, the neural network architecture 220 employs the results of the composite objective function L to optimize weights across a plurality of layers. The optimization of the weights enables the neural network architecture 220 to maintain the structural differentiation required for artifact-free novel view synthesis.

In implementations employing a transformer-based architecture, a transformer block 602 at each layer l includes a multi-head self-attention layer 608, a multilayer perceptron layer 610, and a layer normalization operation. For a concatenated input

$$[ {x}_{l}^{s} , {x}_{l}^{t} ] ,$$

including source tokens 217 (represented as

$$[ {x}_{l}^{s} , {x}_{l}^{t} ] ,$$

which may also be referred to herein as a first set of descriptors) and target tokens 218 (represented as

$${x}_{l}^{t} ,$$

which may also be referred to herein as a second set of descriptors), the neural network architecture 220 performs a sequence of computational processes. The neural network architecture 220 assigns the source tokens 217 and the target tokens 218 to represent distinct visual perspectives for each respective image within a training environment or an inference environment. In some implementations, the sequence of computational processes follows the mathematical relationship defined by Equation (5), resulting in an integrated feature representation that maintains the structural differentiation between the source tokens 217 and the target tokens 218 throughout the depth of the stack of transformer blocks 222:

$$\begin{matrix}[ {x}_{l}^{s} , {x}_{l}^{t} ] = [ {x}_{l}^{s} , {x}_{l}^{t} ] + {SelfAttn}_{l} ( [ {x}_{l}^{s} , {x}_{l}^{t} ] ) \\ [ {x}_{l}^{s} , {x}_{l}^{t} ] = [ {x}_{l}^{s} , {x}_{l}^{t} ] + {FFN}_{l} ( {LN}_{l} ( [ {x}_{l}^{s} , {x}_{l}^{t} ] ) ) .\end{matrix} \qquad ( 5 )$$

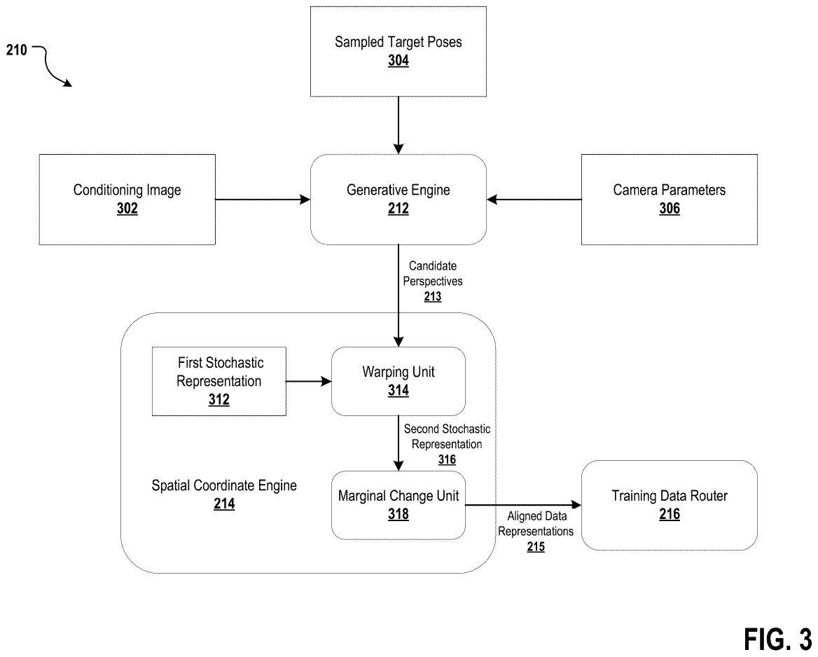

FIG. 3 illustrates an example data pipeline 210 configured to generate data representations of an environment. The data pipeline 210 includes a generative engine 212 and a spatial coordinate engine 214. The generative engine 212 performs a multi-view diffusion process to generate candidate perspectives 213. The generative engine 212 receives a conditioning image 302 and camera parameters 306 to establish a scene context. In some implementations, the generative engine 212 employs the conditioning image 302 (represented as I_{c}) and the camera parameters 306 (represented as camera conditioning C_{c}) to generate candidate perspectives 213 (represented as I_{gen}) at sampled target poses 304 (represented as C_{gen}). The generative engine 212 produces the candidate perspectives 213 according to the relationship defined in Equation (6). The generative engine 212 provides the candidate perspectives 213 to the spatial coordinate engine 214.

$${I}_{gen} \sim DM ( {I}_{gen} \vert {C}_{gen} , {C}_{c} , {I}_{c} ) \qquad ( 6 )$$

The spatial coordinate engine 214 performs mathematical alignment of data across each of the candidate perspectives 213. The spatial coordinate engine 214 includes a warping unit 314 and a marginal change unit 318. In some implementations, the warping unit 314 performs a warping operation on a first stochastic representation 312 (represented as N₁) associated with a conditioning viewpoint to produce a second stochastic representation 316 (represented as Nᵢ) associated with a target viewpoint. The warping unit 314 executes the warping operation by first unprojecting the pixels of the first stochastic representation 312 into a three-dimensional point cloud based on depth estimates and the conditioning camera pose. The warping unit 314 then projects the three-dimensional point cloud onto a camera plane of the target viewpoint using a perspective transformation matrix. The warping operation is based on a geometric relationship between the conditioning viewpoint and the target viewpoint, following the mathematical relationship defined in Equation (10).

$${N}_{i} = warp ( N 1 , inv ( [ Ri , ti ] ) [ R 1 , t 1 ) ] \qquad ( 10 )$$

The mathematical relationship defined in Equation (10) employs ray-based coordinate data (which may also be referred to herein as raymaps) to determine a mapping defining a delta between the conditioning viewpoint and the target viewpoint within a common three-dimensional space, resulting in spatial consistency across the second stochastic representation 316. Within Equation (10), R₁ represents a first rotation matrix and t₁ represents a first translation vector associated with the conditioning camera pose, and Rᵢ represents a second rotation matrix and tᵢ represents a second translation vector associated with a target camera pose.

In instances where the warping operation results in data coordinates outside a defined boundary of the training environment, the marginal change unit 318 applies a marginal change (e.g., a numerical blending process that populates out-of-bounds regions with spatially consistent noise to prevent edge artifacts) to the second stochastic representation 316. The marginal change involves a weighted combination of the second stochastic representation 316 (represented as N₁) and a random numerical distribution (represented as [symbol] (0,I)) according to the relationship defined in Equation (11).

$${N}_{2} = α N 1 + ( 1 - α ) 𝒩 ( 0 , I ) \qquad ( 11 )$$

The weighted combination employs a coefficient α to balance the spatial context of the second stochastic representation 316 with the random numerical distribution, resulting in a spatially consistent data state for regions outside of the conditioning viewpoint.

The alignment and the marginal change performed by the spatial coordinate engine 214 result in aligned data representations 215 characterized by a spatially consistent data state. The aligned data representations 215 include the conditioning image 302 and the plurality of candidate perspectives 213. The spatially consistent data state provides a unified initialization for subsequent diffusion steps to reduce feature divergence among the plurality of candidate perspectives 213. The aligned data representations 215 are subsequently employed to extract the source tokens 217 and the target tokens 218.

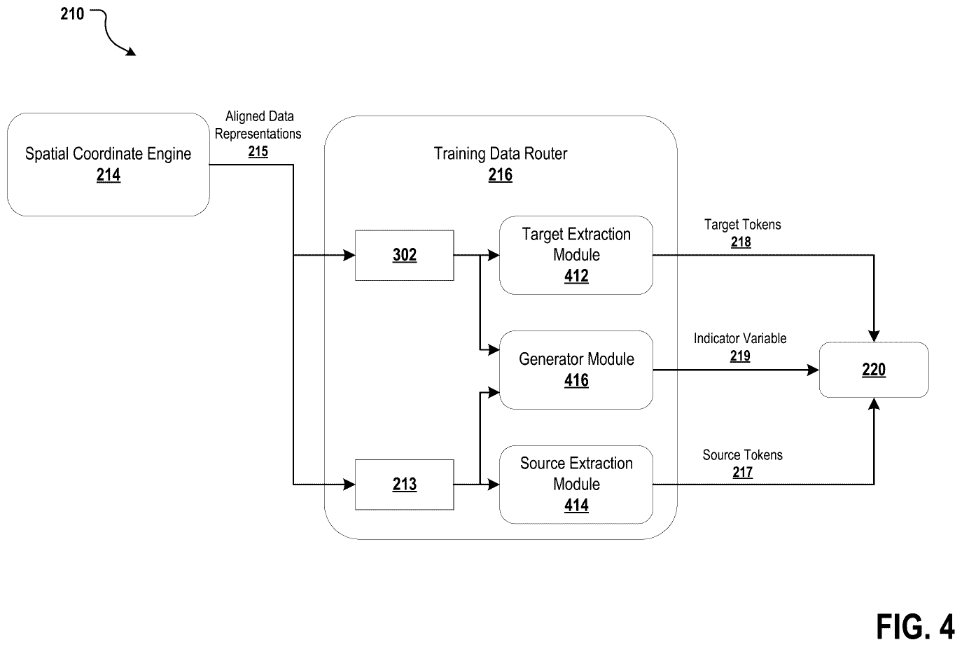

FIG. 4 illustrates an example assignment of data tokens derived from a plurality of perspectives. The training data router 216 manages the routing of visual information between a data pipeline 210 and a neural network architecture 220. The training data router 216 receives the aligned data representations 215 from the spatial coordinate engine 214. The aligned data representations 215 include a conditioning image 302 and a plurality of candidate perspectives 213 produced by a generative engine 212. The training data router 216 assigns the conditioning image 302 as a target perspective. The conditioning image 302 represents an artifact-free visual representation of an environment. The training data router 216 employs a generator module 416 to determine an indicator variable 219. The generator module 416 performs feature extraction on the conditioning image 302 and the plurality of candidate perspectives 213 to extract visual features, such as high-frequency edge density and color-channel variance, and structural features, such as ray-origin consistency within a shared coordinate system. The generator module 416 feeds the visual features and the structural features into a trained classification model to determine a categorical metadata signal for the indicator variable 219. The training data router 216 employs a target extraction module 412 to extract target tokens 218 from the conditioning image 302.

The training data router 216 assigns at least one perspective of the plurality of candidate perspectives 213 within the aligned data representations 215 as a source perspective. In some implementations, the training data router 216 employs a source extraction module 414 to sample source perspectives (represented as I_{src}) and source camera poses (represented as C_{src}) from the plurality of candidate perspectives I_{gen} and associated camera parameters C_{gen} according to the relationship defined in Equation (7):

$${I}_{src} , {C}_{src} \sim {I}_{gen} , {C}_{gen} \qquad ( 7 )$$

The source extraction module 414 selects the source perspectives from the plurality of candidate perspectives for inclusion in the training data payload 211 to provide a visual context for the training environment. The selecting of the source perspectives results in the generation of source tokens 217 that encapsulate the visual context of the synthetic environment.

The plurality of candidate perspectives 213 can include reconstruction artifacts resulting from a multi-view diffusion process. The training data router 216 employs a source extraction module 414 to extract source tokens 217 from the candidate perspectives 213. The assignment of the conditioning image 302 as the target perspective (which defines a constraint for the generative engine 212) for training a neural network architecture 220 causes an optimization of parameters within the neural network architecture 220 toward a reconstruction of high-fidelity features. The training data router 216 employs the generator module 416 to assign categorical values to the indicator variable 219 based on a determination of the assigned roles of the conditioning image 302 and the candidate perspectives 213. The generator module 416 applies a trained neural network to the extracted visual features and the structural features to classify the conditioning image 302 and the candidate perspectives 213 as either a first set of data tokens or a second set of data tokens. The use of the candidate perspectives 213 as source perspectives provides context for an environment while isolating potential artifacts within the source tokens 217. The training data router 216 provides a training data payload 211 (including the target tokens 218, the source tokens 217, and the indicator variable 219) to the neural network architecture 220 for a token-disentangled modulation process.

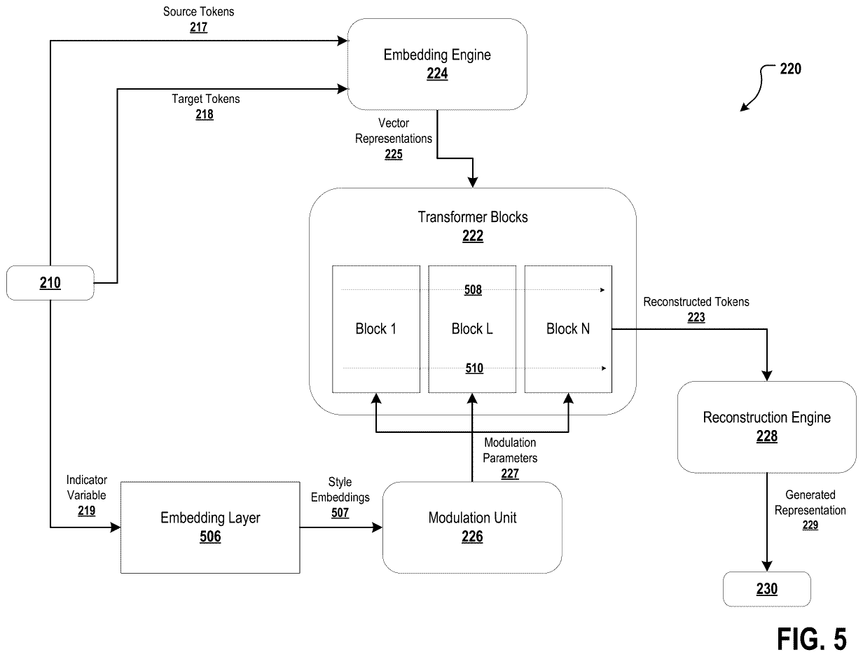

FIG. 5 illustrates an example arrangement of transformer blocks within a neural network architecture 220. The neural network architecture 220 receives the training data payload 211 from the data pipeline 210. The neural network architecture 220 employs an embedding engine 224 to transform the source tokens 217 and the target tokens 218 from the training data payload 211 into vector representations 225. Simultaneously, the neural network architecture 220 directs the indicator variable 219 from the training data payload 211 to an embedding layer 506 to specify an origin of the source tokens 217 and the target tokens 218. The indicator variable 219 assigns a first categorical value to the source tokens 217 and a second categorical value to the target tokens 218. The embedding layer 506 transforms the categorical values of the indicator variable 219 into style embeddings 507. The neural network architecture 220 employs a modulation unit 226 to transform the style embeddings 507 into modulation parameters 227 (such as scale and bias values).

The stack of transformer blocks 222 receives the vector representations 225 and the modulation parameters 227 to process data through a sequence of layers. The stack of transformer blocks 222 includes a plurality of sequential processing blocks, illustrated as Block 1, a representative intermediate Block L, and a terminal Block N, to provide a computational depth sufficient for multi-view feature alignment. As one example configuration, the stack of transformer blocks 222 employs twenty-four sequential processing blocks. The stack of transformer blocks 222 processes the source tokens 217 and the target tokens 218 (as represented within the vector representations 225) simultaneously while employing the modulation parameters 227 to maintain distinct processing paths, represented as a source processing path 508 and a target processing path 510. The stack of transformer blocks 222 has a vector dimensionality that reserves distinct indices for the source tokens 217 and the target tokens 218 through the depth of the stack of transformer blocks 222. The maintaining of the source processing path 508 and the target processing path 510 based on categorical values of the indicator variable 219 results in a separation of features incorporating spatial context from the source tokens 217 while ensuring a programmatic exclusion of synthetic edge artifacts throughout each layer of the depth of the neural network architecture 220. By modifying vector values of the target tokens 218 independently of the source tokens 217, the stack of transformer blocks 222 ensures that visual noise originating from the candidate perspectives 213 does not infuse into the reconstructed target features. To ensure numerical reliability during an optimization process, the stack of transformer blocks 222 maintains parameter stability without an execution of a gradient clipping operation by employing a specific structural configuration at each layer.

Following the processing within the stack of transformer blocks 222, the terminal Block N provides processed features to a reconstruction engine 228 as reconstructed tokens 223. The reconstructed tokens 223 represent a generated version of the target tokens 218 as optimized for the environment. The reconstruction engine 228 employs the reconstructed tokens 223 and performs an unpatchifying operation to generate a generated representation 229. The generating of the generated representation 229 results in a high-fidelity visual output where target features are reconstructed and artifacts identified via the modulation parameters 227 are discarded.

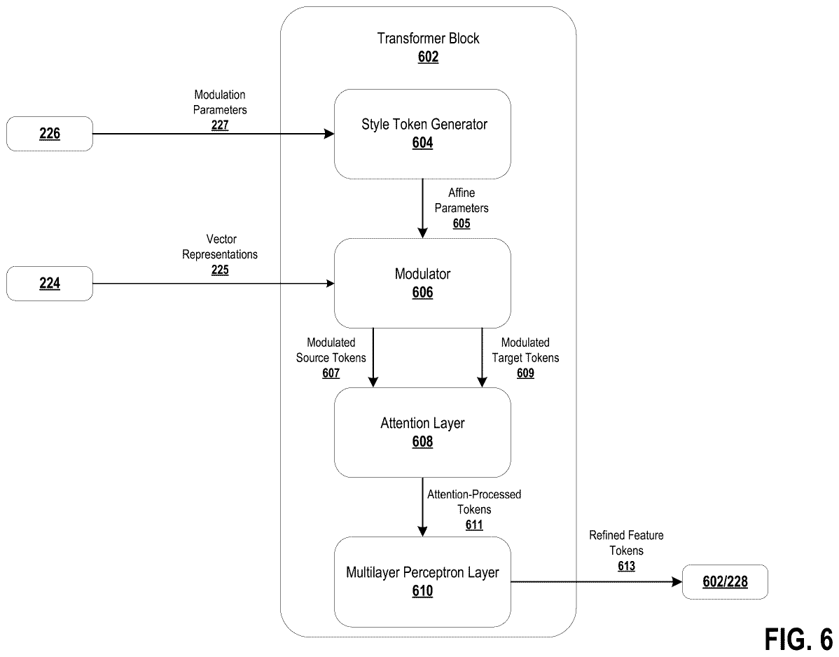

FIG. 6 illustrates an example transformer block 602 configured to perform modulation of the source tokens 217 and the target tokens 218. The transformer block 602 receives the source tokens 217 and the target tokens 218 as input within the vector representations 225. To facilitate the isolation of synthetic artifacts, the transformer block 602 employs a style token generator 604 and a modulator 606 to perform a structural differentiation of the source tokens 217 and the target tokens 218 based on modulation parameters 227 received from the modulation unit 226. The transformer block 602 includes an attention layer 608 and a multilayer perceptron layer 610 to perform spatial reasoning and feature refinement. The transformer block 602 produces refined feature tokens 613 and provides the refined feature tokens 613 to a subsequent processing stage, such as a subsequent transformer block 602 within the stack of transformer blocks 222 or a reconstruction engine 228.

The style token generator 604 transforms the modulation parameters 227 into specific scale parameters and bias parameters for a layer of the transformer block 602. The style token generator 604 employs a linear transformation to produce the modulation parameters for the source tokens 217 and the target tokens 218 based on categorical values provided by the indicator variable 219. In some implementations, the style token generator 604 calculates the specific scale parameters and the bias parameters for the source tokens 217 and the target tokens 218 to produce affine parameters 605 according to the mathematical relationship defined in Equation (8):

The style token generator 604 transforms the modulation parameters 227 into specific scale parameters and bias parameters for a layer of the transformer block 602. The style token generator 604 employs a linear transformation to produce the modulation parameters for the source tokens 217 and the target tokens 218 based on categorical values provided by the indicator variable 219 (represented as δ). In some implementations, the style token generator 604 calculates specific scale parameters (represented as σ) and bias parameters (represented as μ) for the source tokens 217 and the target tokens 218 to produce affine parameters 605 according to the mathematical relationship defined in Equation (8):

$$\begin{matrix}style = Linear ( Embed ( δ ) ) \\ [ σ , μ ] = {Linear}_{l} ( style ) \\ Mod ( x ) = ( 1 + σ ) x + μ \\ [ {x}_{l}^{s} , {x}_{l}^{t} ] = {Mod}_{s , t} ( [ {x}_{l}^{s} , {x}_{l}^{t} ] ) = [ {Mod}_{s} ( {x}_{l}^{s} ) , {Mod}_{t} ( {x}_{l}^{t} ) ]\end{matrix} \qquad ( 8 )$$

The style token generator 604 derives the scale parameters and the bias parameters from a style vector produced by a linear projection of an embedding of the indicator variable δ.

The modulator 606 applies the affine parameters 605 received from the style token generator 604 to the source tokens 217 and the target tokens 218 to produce distinct feature representations. The modulator 606 performs an affine transformation of the numerical values within the source tokens 217 and the target tokens 218. For the source tokens 217, the modulator 606 applies source modulation parameters from the affine parameters 605 to produce modulated source tokens 607. For the target tokens 218, the modulator 606 applies target modulation parameters from the affine parameters 605 to produce modulated target tokens 609. The applying of the affine parameters 605 independently ensures that the modulated source tokens 607 and the modulated target tokens 609 maintain separate feature distributions to prevent a propagation of source artifacts during subsequent reasoning steps.

Attention layer 608 computes spatial dependencies between the modulated source tokens 607 and the modulated target tokens 609 within the transformer block 602. The attention layer 608 employs a multi-head self-attention mechanism to identify correlations between different regions of an environment. The attention layer 608 receives the modulated source tokens 607 and the modulated target tokens 609 to ensure that the spatial reasoning is performed on differentiated features. In some implementations, the attention layer 608 applies a query-key normalization (e.g., a scaling operation that restricts numerical ranges of query vectors and key vectors to prevent softmax saturation) and attention biases (e.g., additive values applied to attention scores to prioritize specific spatial relationships or regulate gradient flow) to each attention head to prevent numerical saturation. The applying of the query-key normalization and the attention biases results in a stabilized attention score distribution that facilitates the maintenance of parameter stability throughout a training cycle. Following the spatial reasoning, the attention layer 608 produces attention-processed tokens 611 and provides the attention-processed tokens 611 to the multilayer perceptron layer 610.

Multilayer perceptron layer 610 performs a sequential transformation of data through a series of fully connected layers. The multilayer perceptron layer 610 refines the attention-processed tokens 611 produced by the attention layer 608 to generate refined feature tokens 613. In some implementations, the modulator 606 applies scale parameters and bias parameters before or after the multilayer perceptron layer 610. In some implementations, the sequence of computational processes within the transformer block 602 follows the mathematical relationship defined by Equation (9):

$$\begin{matrix}[ {\hat{x}}_{l}^{s} , {\hat{x}}_{l}^{t} ] = {Mod}_{s , t}^{1} ( [ {x}_{l}^{s} , {x}_{l}^{t} ] ) \\ [ {x}_{l}^{s} , {x}_{l}^{t} ] = [ {x}_{l}^{s} , {x}_{l}^{t} ] + [ {σ}_{l}^{s 1} , {σ}_{l}^{t 1} ] ⊙ SelfAttn ( [ {\hat{x}}_{l}^{s} , {\hat{x}}_{l}^{t} ] ) \\ [ {\hat{x}}_{l}^{s} , {\hat{x}}_{l}^{t} ] = {Mod}_{s , t}^{2} ( [ {x}_{l}^{s} , {x}_{l}^{t} ] ) \\ [ {x}_{l}^{s} , {x}_{l}^{t} ] = [ {x}_{l}^{s} , {x}_{l}^{t} ] + [ {σ}_{l}^{s 2} , {σ}_{l}^{t 2} ] ⊙ {FFN}_{l} ( {LN}_{l} ( [ {\hat{x}}_{l}^{s} , {\hat{x}}_{l}^{t} ] ) )\end{matrix} \qquad ( 9 )$$

### Within Equation (9),

$$[ {\hat{x}}_{l}^{s} , {\hat{x}}_{l}^{t} ]$$

represents a first set or pic-modulated tokens and a second set of pre-modulated tokens, and the coefficients

$$[ {σ}_{l}^{s 1} , {σ}_{l}^{t 1} ] and [ {σ}_{l}^{s 2} , {σ}_{l}^{t2} ] ,$$

represent layer-wise scaling factors for the attention layer 608 and the multilayer perceptron layer 610, (e.g., a computational unit including fully connected layers and non-linear activation functions that refines descriptor values), respectively. The transformer block 602 applies the layer-wise scaling factors via an element-wise multiplication to the outputs of the attention layer 608 and the multilayer perceptron layer 610. The applying of the layer-wise scaling factors results in a maintenance of the structural differentiation of the source tokens 217 and the target tokens 218 throughout the refinement process. Following the sequential transformation, the transformer block 602 provides the refined feature tokens 613 as a data payload for a subsequent processing stage of the neural network architecture 220.

The applying of the scale parameters and the bias parameters within the transformer block 602 produces distinct feature distributions for the source tokens 217 and the target tokens 218. The structural differentiation prevents a feature alignment problem where source features and target features converge toward similar representations within the depth of the neural network architecture 220. By maintaining separate feature distributions based on the indicator variable 219, the transformer block 602 excludes visual noise and synthetic edge artifacts from the generated visual features. Specifically, the modulation parameters 227 provide a technical solution by reconfiguring an arithmetic state of a processing system to discard numerical high-frequency noise and unwanted outlines identified by the indicator variable 219 as originating from a first set of data tokens. Only relevant spatial context from the source tokens 217 influences the numerical parameters of the target tokens 218, while artifacts from synthetic source perspectives are discarded during a fusion of features to produce a reconstructed version of the target perspective.

Technical implementation details for the training and operation of the neural network architecture 220 include computational configurations and data parameters selected to facilitate weight convergence. The configurations and the data parameters are provided as non-limiting examples to illustrate specific implementations and are not intended to limit the neural network architecture 220 to any single set of values. In some implementations, the neural network architecture 220 employs the differentiation of the source tokens 217 and the target tokens 218 to employ synthetic training data while preventing a propagation of artifacts into the optimized weights. Only relevant information from clean target perspectives influences the numerical parameters of the neural network architecture 220, while artifacts from synthetic source perspectives are discarded during a fusion of the source tokens 217 and the target tokens 218 based on the indicator variable 219. An electronic processor executes an optimization process using an optimization algorithm.

The training process employs a moving averaging at a rate selected to stabilize parameters of the neural network architecture 220. Example rates for the moving averaging include values selected to reduce numerical variance during the training process. The training process calculates a current state of the weights as a weighted combination of a previous state of the weights and a new update to the weights to ensure parameter consistency. The structural configuration of the transformer blocks 602, including the query-key normalization and the attention biases, facilitates a stable training process that removes a requirement for an execution of a gradient clipping operation. The neural network architecture 220 employs a stack of transformer blocks 222. The number of transformer blocks in the stack of transformer blocks 222 can vary based on a desired computational depth. Each transformer block 602 has a vector dimensionality configured to maintain a separation of data features. Transformation layers within the embedding engine 224 employ a resolution-based partitioning for partitioning visual representations. Example partitioning schemes include subsetting the visual representations into a plurality of discrete portions.

Training datasets for the neural network architecture 220 include multi-view scene datasets comprising a plurality of representations. While various collections of image sequences or three-dimensional environments are suitable for training, the neural network architecture 220 can be trained on any collection of spatial data representations. For training scene-level synthesis tasks, the neural network architecture 220 employs a plurality of source viewpoints and at least one target viewpoint. The training process is performed using a batch size selected based on available memory of an electronic processor. Synthetic data generation by the data pipeline 210 employs a multi-view diffusion model to produce a plurality of synthetic environments. The data pipeline 210 generates a collection of synthetic scenes. Each synthetic scene includes a plurality of viewpoints. Viewpoints for synthetic data generation are defined by sampling camera trajectories and converting camera parameters into coordinate data defining an origin and a direction (which may also be referred to herein as orientation data). Visual representations are converted to a resolution selected for computational efficiency before processing by the neural network architecture 220 as source tokens 217 and target tokens 218.

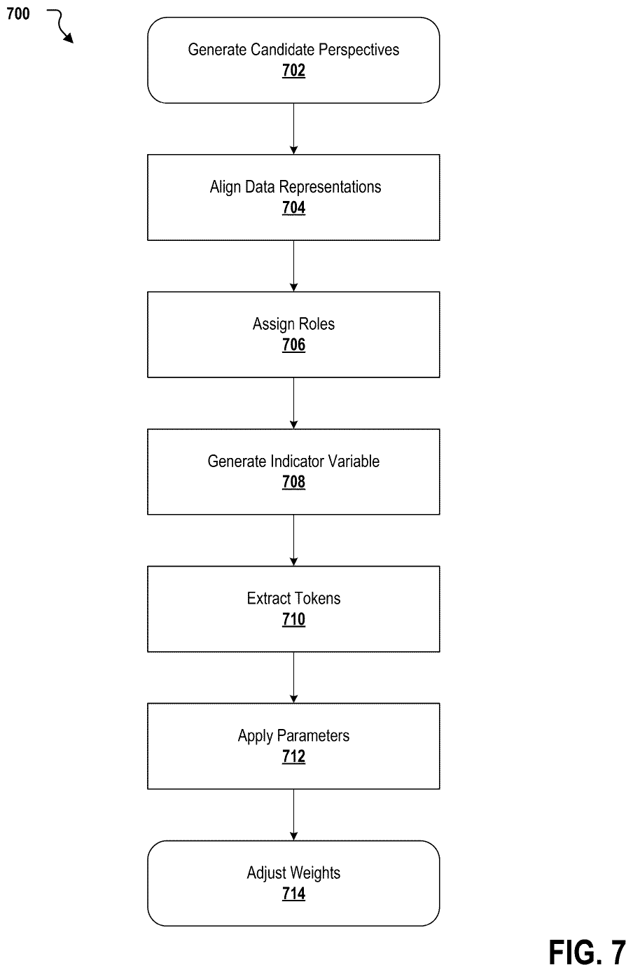

FIG. 7 illustrates an example process 700 for generating source tokens 217 and target tokens 218 to facilitate an optimization of parameters for a neural network architecture 220. The process 700 develops a data path through the neural network architecture 220 to ensure that features from synthetically-generated imagery are employed for a reconstruction of a target perspective. At step 702, the data pipeline 210 generates a plurality of candidate perspectives 213 of the training environment based on a conditioning image 302. The generative engine 212 employs a multi-view diffusion model to produce the candidate perspectives 213. The generating of the candidate perspectives 213 results in a synthetic dataset representing multiple viewpoints of a three-dimensional space. From step 702, the process 700 proceeds to step 704.

At step 704, the spatial coordinate engine 214 aligns data representations of the candidate perspectives 213 by performing a warping operation on stochastic representations. The spatial coordinate engine 214 employs relative camera poses to transform the stochastic representations into a shared coordinate system. The alignment of the data representations results in a spatially consistent data state throughout a multi-view diffusion process. From step 704, the process 700 proceeds to step 706.

At step 706, the training data router 216 assigns roles to visual representations for a training cycle. The training data router 216 assigns the conditioning image 302 as a target perspective and assigns the candidate perspectives 213 as source perspectives. The assigning of the roles results in a role-specific categorization of the visual representations. From step 706, the process 700 proceeds to step 708.

At step 708, the training data router 216 employs a generator module 416 to generate an indicator variable 219. The generator module 416 analyzes the conditioning image 302 and the candidate perspectives 213 to assign categorical values to the indicator variable 219 based on the roles assigned at step 706. The generating of the indicator variable 219 results in metadata configured to identify a token origin. From step 708, the process 700 proceeds to step 710.

At step 710, the training data router 216 extracts source tokens 217 and target tokens 218 from the visual representations. The training data router 216 employs a target extraction module 412 and a source extraction module 414 to partition the visual representations into discrete portions and combine the discrete portions with ray-based coordinate data. The training data router 216 combines the source tokens 217, the target tokens 218, and the indicator variable 219 into a training data payload 211. The extracting of the source tokens 217 and the target tokens 218 transforms visual and geometric information into multidimensional vectors formatted for the neural network architecture 220. From step 710, the process 700 proceeds to step 712.

At step 712, the modulation unit 226 applies a set of parameters (e.g., scale parameters and bias parameters) to the source tokens 217 and the target tokens 218 at a plurality of layers of the neural network architecture 220. The modulation unit 226 differentiates source data from target data based on categorical values provided by the indicator variable 219. The applying of the set of parameters to the source tokens 217 and the target tokens 218 produces a structural differentiation that prevents a blending of source artifacts into target reconstructions. From step 712, the process 700 proceeds to step 714.

At step 714, the neural network architecture 220 adjusts weights based on a combination of a per-pixel comparison (at a pixel level) and a comparison between feature layers. The neural network architecture 220 employs a composite objective function to calculate a loss value between a generated representation 229 and the conditioning image 302. The adjusting of the weights minimizes a numerical variance between generated data and target data to produce an optimized view synthesis model. From step 714, the process 700 ends or repeats.

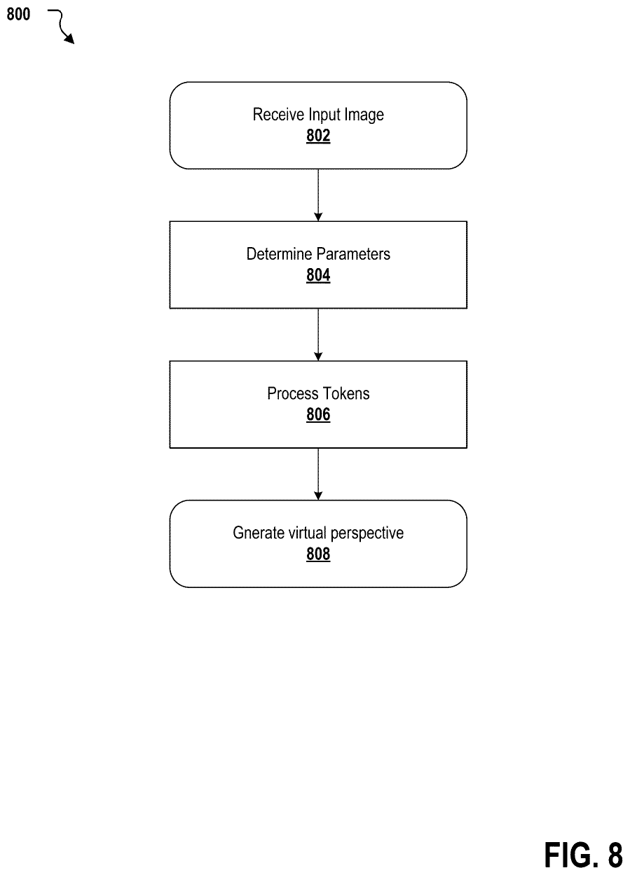

FIG. 8 illustrates an example process 800 for generating a perspective of an environment. At step 802, the data acquisition module 202 receives an input image of the inference environment. The input image may correspond to the conditioning image described above with reference to FIG. 3. The data acquisition module 202 retrieves visual features defining a context for view synthesis. The receiving of the input image establishes the visual basis for generating unseen viewpoints. From step 802, the process 800 proceeds to step 804.

At step 804, the neural network architecture 220 determines geometric parameters for a virtual perspective different from a perspective of the input image. The determining of the geometric parameters involves analyzing data representations sampled from a probability distribution to establish initial spatial distributions. The neural network architecture 220 employs a spatial mapping of rays to define a target viewpoint in a common three-dimensional space based on the mapping defining a delta between the input image and the target viewpoint. The determining of the geometric parameters provides coordinate constraints for generating target tokens 218. From step 804, the process 800 proceeds to step 806.

At step 806, the neural network architecture 220 processes the input image and the geometric parameters through a stack of transformer blocks 222. The embedding engine 224 extracts target tokens 218 from the input image and the geometric parameters. The modulation unit 226 applies scale parameters and bias parameters to the target tokens 218, resulting in a production of disentangled feature representations throughout a depth of the neural network architecture 220. The processing of the target tokens 218 isolates visual features for the third perspective from potential noise in the input image. From step 806, the process 800 proceeds to step 808.

At step 808, the reconstruction engine 228 generates the virtual perspective based on reconstructed tokens 223 from the stack of transformer blocks 222. The reconstructed tokens 223 represent a generated version of the target tokens 218 as optimized for the inference environment. The reconstruction engine 228 unpatchifies the reconstructed tokens 223 to generate a generated representation 229. The generating of the virtual perspective produces a high-fidelity view and excludes visual noise and synthetic edge artifacts from the generated representation 229 based on the structural differentiation maintained within the stack of transformer blocks 222. The exclusion results in a visual reconstruction that inherits a spatial context of the input image while programmatically discarding generative irregularities detected by the neural network architecture 220. From step 808, the process 800 ends or repeats.

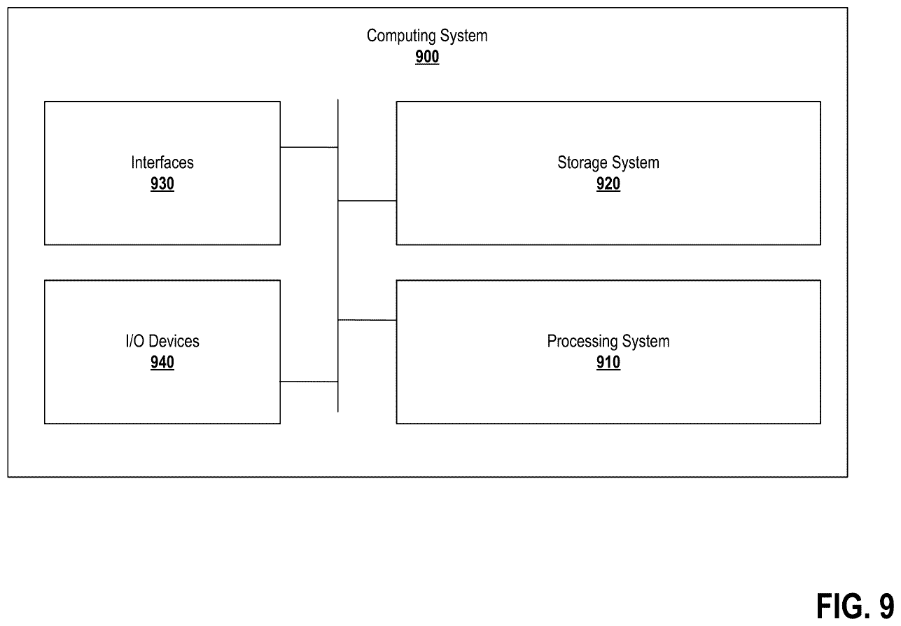

FIG. 9 illustrates an example computing system 900 configured for implementation of data flows, processes, and scenarios described herein. The computing system 900 represents a hardware configuration for a server system or a device configured to execute operations of the data pipeline 210 and the neural network architecture 220. In some implementations, the computing system 900 includes a processing system 910, a storage system 920, interfaces 930, and input/output (I/O) devices 940. The processing system 910 is operatively linked and communicably coupled to the interfaces 930, the I/O devices 940, and the storage system 920. The storage system 920 represents a memory that stores machine-readable instructions. The processing system 910 employs internal circuitry, such as arithmetic logic units, registers, and memory controllers, to execute the machine-readable instructions. The execution of the machine-readable instructions by the processing system 910 causes the computing system 900 to perform the technical solutions described herein. The physical state of the processing system 910 is transformed during an execution of the machine-readable instructions to facilitate token-disentangled view synthesis.

The processing system 910 includes circuitry configured for retrieval and execution of operating software from the storage system 920. The processing system 910 executes instructions associated with the data pipeline 210 and the neural network architecture 220. The processing system 910 is implemented using one or more processors, such as a central processing unit (CPU), a digital signal processor (DSP), or a graphics processing unit (GPU). The processing system 910 is configured for parallel execution of matrix operations associated with transformer-based modeling and style token generation. Hardware-accelerated architectures within the processing system 910 provide for low-latency processing for operation of the neural network architecture 220. The processing system 910 communicates with external hardware components via the interfaces 930.

The storage system 920 includes volatile and nonvolatile media for storage of information. The storage system 920 includes at least one non-transitory computer-readable medium. The storage system 920 stores operating software including machine-readable instructions for performance of the generative engine 212 and the modulation unit 226. The storage system 920 also stores data used during an execution of view synthesis processes, such as stochastic data representations, ray-based coordinate data, and spatial embeddings. During operation, portions of the storage system 920 are allocated for buffering candidate perspectives 213, source tokens 217, target tokens 218, indicator variables 219, and reconstructed tokens 223 during processing by the neural network architecture 220. The allocation of the storage system 920 results in data streams being available for modification of a representation of a three-dimensional environment.

Interfaces 930 include components configured for communication over communication links, such as network cards, ports, or radio frequency circuitry. Interfaces 930 are configured for communication over metallic, wireless, or optical links and for various communication formats. For example, in some implementations, interfaces 930 receive updates for the neural network architecture 220 from a remote storage location. Receiving updates from a remote storage location facilitates a retrieval of updated weights or model parameters through a network connection. Distributed implementations provide a technical path for updating the neural network architecture 220 by synchronizing the neural network architecture 220 with a central repository. Interfaces 930 also include circuitry configured to ingest and transmit data streams within a sequential processing chain. Interfaces 930 execute a transfer of visual representations, conditioning images, stochastic data representations, data tokens, and generated perspectives between hardware components. Furthermore, interfaces 930 orchestrate data exchanges associated with the data pipeline 210, the neural network architecture 220, the process 700, and the process 800. Interfaces 930 establish a hardware abstraction layer, resulting in the processing system 910 interacting with disparate data modalities according to a standardized communication protocol.

I/O devices 940 include peripherals for interaction between a user and the computing system 900, such as keyboards, monitors, or touch-sensitive displays. In some implementations, the I/O devices 940 include one or more sensors configured to receive or detect visual information of an environment. The I/O devices 940 enable a user to provide configuration parameters for the generative engine 212 or the modulator 606.

The machine-readable instructions stored in the storage system 920, when executed by the processing system 910, physically configure general-purpose computing hardware into a special-purpose machine for performing the claimed method. Execution of the machine-readable instructions transforms an operational state of an arithmetic logic unit, registers, and memory controllers within the processing system 910. For example, the machine-readable instructions redirect data flows to specific arithmetic registers that determine scale parameters and tangibly alter a voltage state of a hardware register representing a modulation layer of the neural network architecture 220. The machine-readable instructions physically configure the processing system 910 as a hardware-integrated gate that reserves specific memory indices for different token types. The hardware-integrated gate prevents the neural network architecture 220 from infusing artifacts from the data pipeline 210 into a target reconstruction by restricting data paths for the source tokens 217 and the target tokens 218 until the modulation unit 226 verifies a token origin via an indicator variable 219. The execution of the machine-readable instructions causes a physical reconfiguration of the processing system 910 to prioritize distinct data flows, which transforms the processing system 910 from a general-purpose processor into a machine configured for disentangled token modulation. The physical reconfiguration of the processing system 910 addresses a technical problem rooted in computer vision hardware, specifically, the inability of standard transformer hardware to isolate out-of-distribution noise from multi-view data. The physical reconfiguration causes a reduction in a number of computational operations relative to systems that perform uniform processing on source and target data by enabling the neural network architecture 220 to selectively discard artifacts at each layer of the stack of transformer blocks 222, thereby optimizing the processing system 910 for the specialized task of artifact-free novel view synthesis.

In some implementations, where the described techniques involve processing environmental metadata, a user provides consent for a collection and analysis of data. For example, the system architecture 200 presents a user with a notification and obtains consent from the user before a retrieval of image data from a data source. In some cases, data may be aggregated to prevent associating the data with a particular user. Furthermore, in some implementations, the system provides the user with tools to manage, review, or delete the data. For example, a user interface provides for a review of a record of generative processing operations or for requesting a deletion of data representations of an environment. In some implementations, the computing system 900 performs an analysis of the data on a local device, which is advantageous for processing information without network transmission to maintain user control over the data representations. In other implementations, the computing system 900 performs an analysis of the data on a remote server, which is advantageous for leveraging high-capacity computational resources while employing the same privacy-centric guardrails as the local device. The framework of user-authorized analysis results in data processing that aligns with user preferences.

In some implementations, a computer program includes software modules. For example, the described processes and data flows are implemented as a set of software modules stored in the storage system 920 and executed by the processing system 910. The software modules include the generative engine 212 and the modulator 606. In an example implementation, the generative engine 212 includes instructions for performing coordinate-to-coordinate transformations and warping operations on stochastic representations. In another example implementation, the modulator 606 includes instructions for performance of an affine transformation to produce distinct feature representations. In various implementations, a computer program includes, in part or in whole, standalone applications, cloud-based services, or combinations thereof.

Although the drawings illustrate hardware and software located within particular devices, the depictions provide examples of the hardware and software arrangements. In some implementations, a system may combine or divide the illustrated components into separate software, firmware, or hardware. For example, a system may distribute logic and processing among a plurality of electronic processors instead of locating and performing the logic and processing within a single electronic processor. A system may locate hardware and software components on the same computing device or distribute the components among different computing devices connected by networks or other communication links.

Moreover, various implementations of the described systems and techniques can be realized in digital electronic circuitry, integrated circuitry, application-specific integrated circuits (ASICs), computer hardware, firmware, software, or combinations thereof. Some implementations can include computer programs that are executable or interpretable on a programmable system including programmable processors. The programmable processors can include special-purpose or general-purpose processors. The programmable processors are coupled to receive data and instructions from, and to transmit data and instructions to, a storage system, input devices, and output devices.

Computer programs, which may also be referred to as programs, software, software applications, executable instructions, or code, include computer-readable or machine instructions for a programmable electronic processor. Computer programs can be implemented in a high-level procedural or object-oriented programming language, or in assembly or machine language. As used herein, the terms “machine-readable medium,” “computer-readable medium,” and “non-transitory computer-readable medium” refer to a computer program product, apparatus, or device used to provide machine instructions or data to a programmable processor. Examples of the devices include magnetic discs, optical disks, memory, and programmable logic devices (PLDs). The term machine-readable medium includes a machine-readable medium that receives machine instructions as a machine-readable signal. The term machine-readable signal refers to a signal used to provide machine instructions or data to a programmable processor.

Unless otherwise defined, the technical terms used herein have the same meaning as commonly understood by one of ordinary skill in the art to which the disclosed subject matter belongs. As used in the specification and the appended claims, the singular forms “a,” “an,” and “the” include plural references unless the context clearly dictates otherwise. Any reference to “or” herein is intended to encompass “and/or” unless otherwise stated.

A number of implementations have been described. Various modifications, including the separation or integration of system components, may be made without departing from the spirit and scope of the disclosure. For example, various alternatives to the described implementations may be employed, and the appended claims are intended to cover variations and changes as fall within the true spirit of the described subject matter.

A number of implementations have been described. Various modifications, including the separation or integration of system components, may be made without departing from the spirit and scope of the disclosure. Various alternatives to the described implementations may be employed, and the appended claims are intended to cover variations and changes as fall within the true spirit of the described subject matter.

What is claimed is:

1. A method comprising:
aligning a plurality of representations of a first perspective in a first environment and a second perspective in the first environment within a three-dimensional space common to the first perspective and the second perspective and based on a mapping between the first perspective and the second perspective;
transforming the plurality of representations into a first set of descriptors representing the first perspective and a second set of descriptors representing the second perspective;
configuring a model based on the first set of descriptors and the second set of descriptors; and
generating a third perspective of a second environment based on an input image of the second environment of the second environment and the model.

2. The method of claim 1, wherein the model includes a plurality of transformer blocks, a transformer block of the plurality of transformer blocks including at least one attention layer and at least one multilayer perceptron layer configured to receive the first set of descriptors and the second set of descriptors.

3. The method of claim 2, wherein configuring the model includes maintaining parameter stability without an execution of a gradient clipping operation by applying a query-key normalization and attention biases at each layer of a plurality of layers of the model.

4. The method of claim 2, wherein configuring the model includes applying a first scale parameter and a first bias parameter to the first set of descriptors and a second scale parameter and a second bias parameter to the second set of descriptors at a plurality of layers of the model.

5. The method of claim 4, wherein applying the first scale parameter and the first bias parameter includes maintaining separate feature distributions through a depth of the model by modulating an input to the at least one attention layer and modulating an output of the at least one multilayer perceptron layer.

6. The method of claim 1, wherein configuring the model includes maintaining separate feature distributions for the first set of descriptors and the second set of descriptors throughout a plurality of layers of the model.

7. The method of claim 6, wherein generating the third perspective includes excluding visual noise present in the first set of descriptors based on the separate feature distributions.

8. The method of claim 7, wherein excluding the visual noise includes identifying a descriptor origin for the first set of descriptors and producing a reconstructed version of the second perspective including spatial context from the first set of descriptors by modifying vector values of the second set of descriptors through the plurality of layers of the model based on the descriptor origin.

9. The method of claim 1, wherein transforming the plurality of representations into the first set of descriptors and the second set of descriptors includes generating a plurality of multidimensional vectors, each multidimensional vector of the plurality of multidimensional vectors representing an integration of visual data extracted from the plurality of representations and coordinate data defining an origin and a direction within the three-dimensional space.

10. The method of claim 1, wherein aligning the plurality of representations includes warping a representation of the plurality of representations from a first system of coordinates associated with the first perspective to a second system of coordinates associated with the second perspective based on the mapping, the representation including data sampled from a probability distribution.

11. The method of claim 10, wherein aligning the plurality of representations includes establishing a spatially consistent data state for regions outside of the first perspective by applying a marginal change to the representation of the plurality of representations in response to determining that warping the representation results in data coordinates outside a boundary of the first environment, the marginal change including a weighted combination of the representation and a random numerical distribution.

12. The method of claim 1, wherein aligning the plurality of representations includes:
generating a plurality of candidate perspectives of the first environment based on a first representation of the first perspective and coordinate data defining an orientation associated with the first perspective; and
selecting at least one candidate perspective of the plurality of candidate perspectives for inclusion in the plurality of representations of the first environment.

13. The method of claim 1, wherein transforming the plurality of representations includes:
assigning a first representation of the plurality of representations as a source perspective, the first representation including data generated by a generative model;
assigning a second representation of the plurality of representations as a target perspective, the second representation defining a constraint for the generative model;
extracting the first set of descriptors from the first representation; and
extracting the second set of descriptors from the second representation.

14. The method of claim 1, wherein configuring the model includes adjusting weights of the model based on a comparison of the third perspective and the second perspective at a pixel level and a comparison of the third perspective and the second perspective at a plurality of feature layers.

15. The method of claim 14, wherein adjusting the weights includes calculating a current state of the weights as a weighted combination of a previous state of the weights and a new update to the weights, the new update to the weights being determined based on the comparison at the pixel level and the comparison at the plurality of feature layers across a sequence of weight updates.

16. The method of claim 1, wherein generating the third perspective includes:
determining an orientation and a spatial mapping defining the third perspective within the second environment;
extracting a third set of descriptors from the input image;
mapping visual features of the third set of descriptors to the second environment based on the orientation and the spatial mapping; and
generating the third perspective by processing the visual features through the model.

17. The method of claim 1, wherein the first environment and the second environment are a same three-dimensional environment.

18. A non-transitory computer-readable medium storing executable instructions that, when executed by an electronic processor, cause the electronic processor to:
align a plurality of representations of a first perspective in a first environment and a second perspective in the first environment within a three-dimensional space common to the first perspective and the second perspective and based on a mapping between the first perspective and the second perspective;
transform the plurality of representations into a first set of descriptors representing the first perspective and a second set of descriptors representing the second perspective;
configure a model based on the first set of descriptors and the second set of descriptors; and
generate a third perspective of a second environment based on an input image of the second environment and the model.

19. The non-transitory computer-readable medium of claim 18, wherein aligning the plurality of representations includes warping a representation of the plurality of representations from a first system of coordinates associated with the first perspective to a second system of coordinates associated with the second perspective based on the mapping, the representation including data sampled from a probability distribution.

20. A system comprising:
a model;
an electronic processor; and
a memory communicably coupled to the electronic processor, the memory storing instructions that, when executed by the electronic processor, cause the electronic processor to:
align a plurality of representations of a first perspective in a first environment and a second perspective in the first environment within a three-dimensional space common to the first perspective and the second perspective and based on a mapping between the first perspective and the second perspective;
transform the plurality of representations into a first set of descriptors representing the first perspective and a second set of descriptors representing the second perspective;
configure the model based on the first set of descriptors and the second set of descriptors; and
generate a third perspective of a second environment based on an input image of the second environment and the model.

21. The system of claim 20, wherein the model includes a plurality of transformer blocks, a transformer block of the plurality of transformer blocks including at least one attention layer and at least one multilayer perceptron layer configured to receive the first set of descriptors and the second set of descriptors.
